(19) United States
(12) Patent Application Publication
(10) Pub. No.: US 2008/0059538 A1
(43) Pub. Date: Mar. 6, 2008

(54) Method and system for synchronizing offline records

(76) Inventor: Andreas Engel, Weinheim (DE)

Correspondence Address: KENYON & KENYON LLP, 1500 K STREET N.W., WASHINGTON, DC, 20005, US

(21) Appl. No.: 11/514,654

(22) Filed: Aug. 31, 2006

(51) Int. Cl. G06F 17/30

(52) U.S. Cl. 707/201

(57) ABSTRACT

A method and system are provided for synchronizing records between a mobile terminal and a records management server. The method includes selecting at least one master file to be synchronized, wherein the master file includes a set of master records and is stored on a records management server, the server configured to store records relevant to enterprise activities and transactions. The method includes copying the master file and the included master records from the server to a mobile terminal, the mobile terminal in intermittent communication with the server over a network. The method includes performing an offline operation on a terminal file and an included set of terminal records. The method includes synchronizing the terminal file to the master file when the mobile terminal is in communication with the server over the network.

### BACKGROUND

In the course of conducting business, enterprises may create and save large amounts of records. A record may be information created, received, and maintained as evidence and information pursuant to legal obligations or in the transaction of business. For example, a record may be a document, a form or template, an email, a telephone log entry, an audio recording, a business partner's contact information, or any other information. Legal obligations to maintain records may arise from governmental regulations, especially in certain industries such as insurance or finance.

The storage of a large amount of records creates the need for record management. Records management is the practice of identifying, classifying, archiving, preserving, and destroying records saved by the enterprise. An enterprise may use a records management system including a records management server, a network, and at least one terminal to manage its electronic records. The records management system may be required to comply with industry standards or governmental regulations.

### BRIEF DESCRIPTION OF THE DRAWINGS

FIG. 1A illustrates an example screen shot of a contact display, in accordance with one embodiment of the present invention.

FIG. 1B illustrates an example screen shot of an email client, in accordance with one embodiment of the present invention.

FIG. 2 illustrates an example procedure for synchronizing records, in accordance with one embodiment of the present invention.

FIG. 3 illustrates an example system for synchronizing records, in accordance with one embodiment of the present invention.

### DETAILED DESCRIPTION

A user within a business or an enterprise may require access to records within a records management server from a terminal while the terminal is not in communication with the server. Such offline use may be required, for example, when the user visits a client's site to collect information. The user may select records to be copied to the terminal. While offline, the user is provided access to copies of the records stored on the terminal. When the terminal is back in communication with the server, the terminal copies of the records may be synchronized with the records on the server.

An example embodiment of the present invention may be a method for synchronizing records. The method may include selecting at least one master file to be synchronized, wherein the master file includes a set of master records and is stored on a records management server, the server configured to store records relevant to enterprise activities and transactions. The method may include copying the master file and the included master records from the server to a mobile terminal, the mobile terminal in intermittent communication with the server over a network. The method may include performing an offline operation on a terminal file and an included set of terminal records. The method may include synchronizing the terminal file to the master file when the mobile terminal is in communication with the server over the network. The offline operation may be selected from the group consisting of: creating a new terminal record associated with the terminal file, modifying an existing terminal record, and deleting an existing terminal record. The file to be synchronized may be selected automatically by the server based on a terminal user's permissions. The master records and terminal records may be selected from the group consisting of: emails, documents, and contact information. The synchronizing may include copying new and updated terminal records to the server. The method may include automatically detecting a network connection between the terminal and the server and beginning the synchronizing when the connection is detected.

Another example embodiment of the present invention may be a system for synchronizing records. The system may include a network, a records management server configured to store records relevant to enterprise activities and transactions, the server including a master database, including at least one master file, each master file including a set master records, and a mobile terminal in intermittent communication with the server over the network, including a local database, including at least one terminal file, each terminal file including a set of terminal records, wherein the terminal file is a copy of the master file wherein the mobile terminal is configured to perform an offline operation on the terminal file, and synchronize the terminal file with the master file when it is in communication with the server over the network. The offline operation may be selected from the group consisting of: creating a new terminal record associated with the terminal file, modifying an existing terminal record, and deleting an existing terminal record. The file to be synchronized may be selected automatically by the server based on a terminal user's permissions. The master records and terminal records may be selected from the group consisting of: emails, documents, and contact information. The synchronizing may include copying new and updated terminal records to the server. The mobile terminal may be configured to automatically detect a network connection between the terminal and the server and beginning the synchronizing when the connection is detected.

Another example embodiment of the present invention may be a method for synchronizing records. The method may include selecting at least one master file to be synchronized, wherein the master file includes a set of master records and is stored on a records management server. The method may include copying the master file and the included master records from the server to a mobile terminal, the mobile terminal in intermittent communication with the server over a network. The method may include performing an offline operation on a terminal file and an included set of terminal records. The method may include synchronizing the terminal file to the master file when the mobile terminal is in communication with the server over the network. The offline operation may be selected from the group consisting of: creating a new terminal record associated with the terminal file, modifying an existing terminal record, and deleting an existing terminal record. The file to be synchronized may be selected automatically by the server based on a terminal user's permissions. The master records and terminal records may be selected from the group consisting of: emails, documents, and contact information. The synchronizing may include copying new and updated terminal records to the server. The method may include automatically detecting a network connection between the terminal and the server and beginning the synchronizing when the connection is detected.

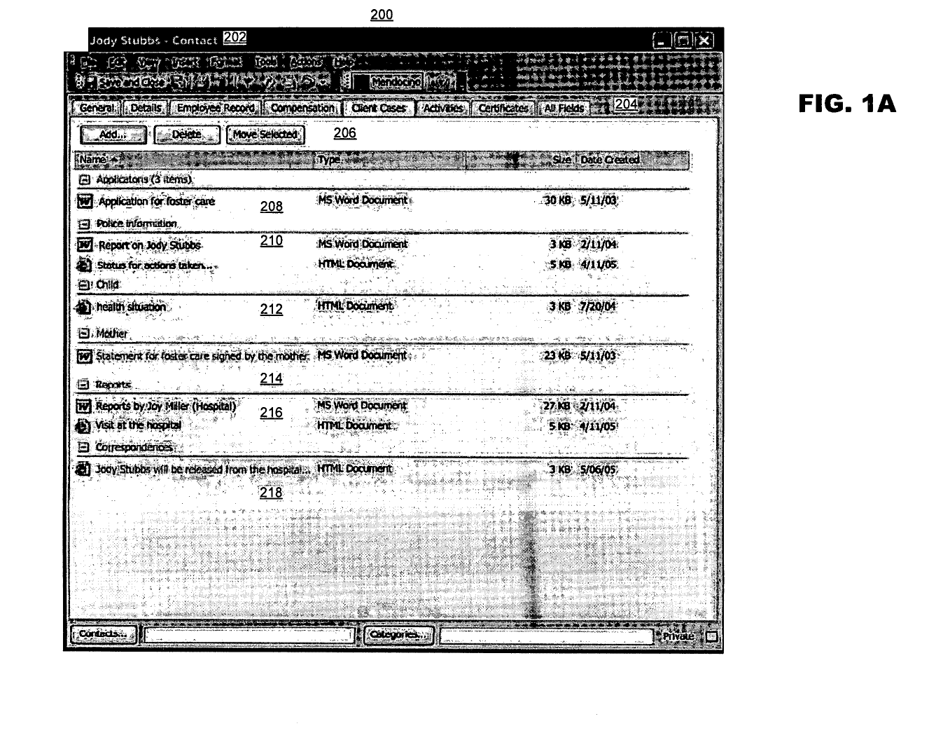

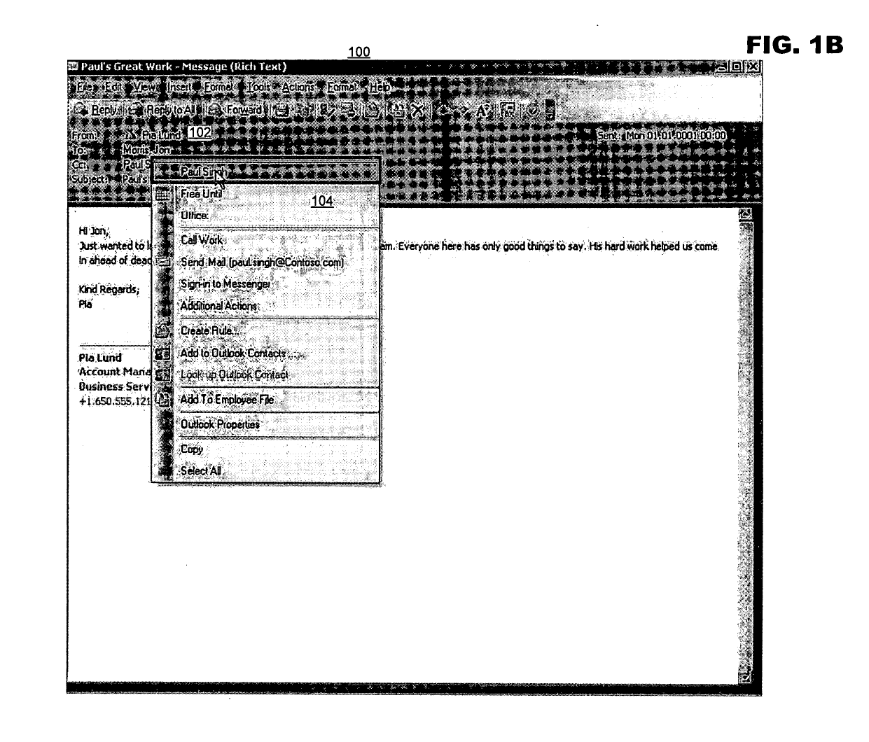

FIG. 1A illustrates an example screen shot of a contact display, in accordance with one embodiment of the present invention. A terminal may provide contact display 200 to a user. The contact display 200 may provide access to all records related to the contact, such as contact information, previously sent emails, and other information. From the contact display 200, the user may select the contact to be synchronized to a mobile terminal for access while offline from the server.

For example, information related to a contact may be stored as records. Records may be associated into files, each file corresponding to a contact within a contact management system. It is understood that the procedure described may be embodied in a variety of different systems, such as an email management system or a document management system.

For example, the mobile terminal may be any mobile computer, such as a laptop computer, a personal digital assistant (PDA). In an alternative embodiment, the records may be synchronized onto a removable media and loaded at a computer local to a user's destination. For example, the removable media may be rewritable, such as a magnetic disk or a flash drive.

In an alternative embodiment, the terminal may display a list of all contacts available to the user, who can then select the contacts to be synchronized to the mobile terminal. In an alternative embodiment, the server may automatically select contacts to be synchronized to the mobile terminal. For example, the server may automatically select contacts for which the user is responsible or has permissions for.

In addition, the user may select a subset of records relating to a contact to be synchronized to the mobile terminal. For example, this may be an option when there are a large number of records related to a contact, and therefore may be impractical to synchronize all the records on the mobile terminal. In an alternative embodiment, the subset of records may be selected by the server based on previously defined user or programmer criteria.

The records may be stored on a records management server and relate to transactions undertaken by an enterprise during its course of business. The records may be organized into files, each file associated with an identifier. Thus, all records associated with a particular business partner may be organized into a single file. For example, the identifier may be a business partner's name, email address, or unique identifying number. The records may include received and sent emails, email attachments, electronic documents and files, audio recordings, or any other digital or other information. A user may thus use the contact display 200 to view previously stored records related to an identifier.

The contact display 200 may display records related to a selected business partner or contact. The records may be retrieved from the records management server and may also be cached at the terminal. Adding or changing records will be reflected in changes to the records stored on the records management server.

The contact display 200 may include a title bar 202. The title bar 202 may display the name of the contact and the name of the window.

The contact display 200 may include tabs 204. The tabs 204 may allow the user to switch between different views, each view providing a different collection of records. For example, views may include: general information about the business partner, detailed information about the business partner, and current related records such as documents and emails.

The contact display 200 may include action buttons 206. The action buttons 206 may provide the user with actions to be conducted on the records displayed. For example, records may be added, deleted, or moved.

The contact display 200 may include records 208, 210, 212, 214, 216, and 218. A record may be an electronic document, an email, or any other information stored on the records management server as a record.

It will be appreciated that the contact display 200 may be modified or configured to display any other collection of records available from the records management server. The records may be displayed at the terminal in various ways depending on how the records are organized or should be presented.

FIG. 1B illustrates an example screen shot of an email client, in accordance with one embodiment of the present invention. For example, the user may access a file and its associated records through a context menu in the email client executing on the mobile terminal. In this embodiment, functionality to access records on a records management server has been added to the email client.

The email client 100 may display an email to the user. The email may include a sender 102 and a context menu 104. The email may also include a recipient, a subject, and a body.

The context menu 104 may display a list of options and actions associated with a name when the name is right clicked in the email client 100. For example, right clicking on a recipient may display a plurality of options 104. One of the options may be to open the file associated with the recipient and view the records associated with the file.

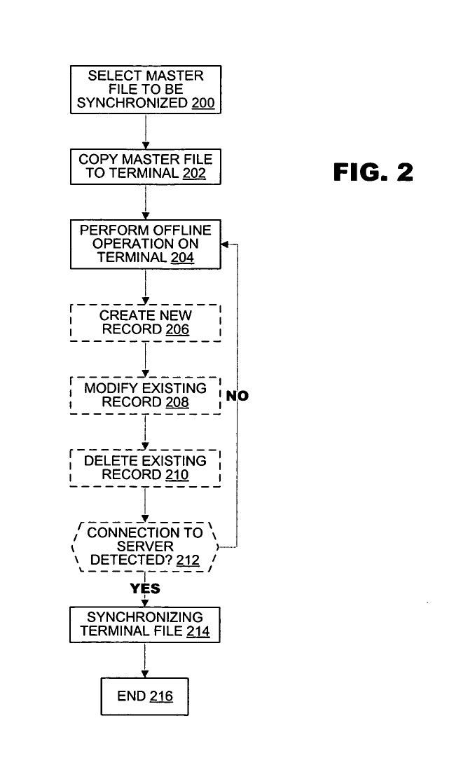

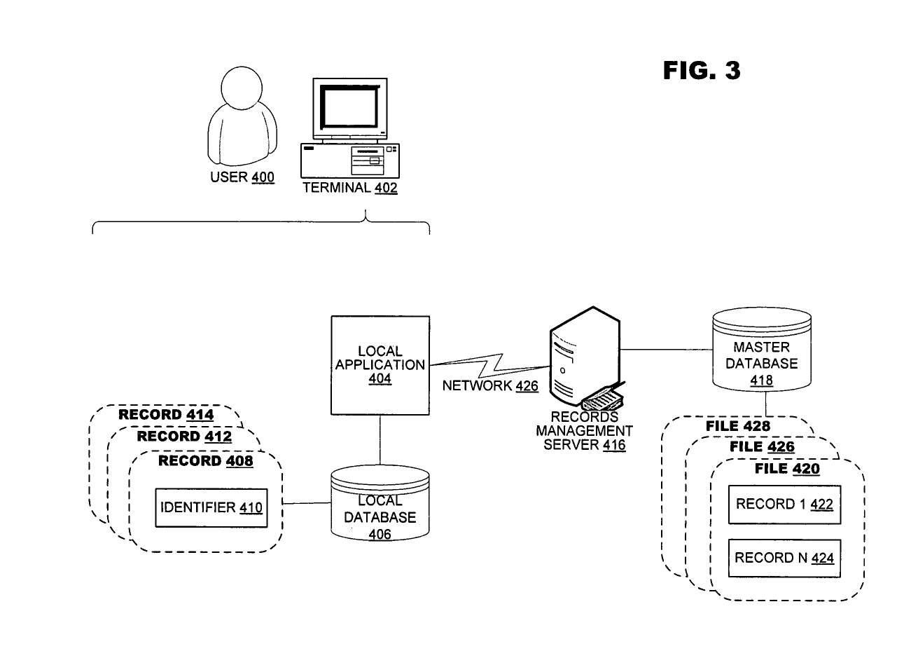

FIG. 2 illustrates an example procedure for synchronizing records, in accordance with one embodiment of the present invention. The procedure may execute on a terminal in intermittent communication with a records management server over a network. The records management server may store all records or a subset of records within an enterprise system. For example, the procedure may execute on a system depicted in FIG. 3.

The procedure may be implemented as functionality in an application that accesses record stored on the server. For example, the application may be a contact management system, an email client, or a document management system.

In 200, the procedure may select a master file to be synchronized. The procedure may include a records management server which includes the master file. The master file may be associated with at least one master record. Each record may be an electronic document and associated together into a file. For example, a file may be associated with a contact in a contact management system. In this embodiment, records may be emails, digital audio recordings of phone conversations, electronic documents, contact information of the contact, or any other information which may be saved on the records management server.

In one embodiment, a user may select the master file to be synchronized. For example, the user may access the records management server through a mobile terminal. The mobile terminal may be a laptop computer or a personal digital assistant (PDA) with software to intermittently communicate with the server.

In another embodiment, the records management server may select the master file to be synchronized. For example, the server may select all files for which the user has permission to access for synchronization. Alternatively, the server may select the master file based on pre-defined rules, such as the last ten master files access by the user.

It is understood that the procedure may also select a subset of master records associated with the master file for synchronization. For example, only recently accessed or created records may be synchronized. Alternatively, only records smaller than a specified size may be synchronized, to save storage space on the mobile terminal.

In 202, the procedure may copy the master file selected in 200 to the mobile terminal. The terminal may be in communication with the server over a network. When the communication link is active, the terminal may copy the master file from the server onto a storage medium accessible by the terminal as a terminal file.

If the terminal file already exists on the terminal, the terminal may update the terminal file as necessary from the master file.

In 204, the terminal may perform an offline operation on the terminal file responsive to user input. For example, the terminal may be taken to an offsite location not in communication with the server. An offline operation may include viewing the terminal file and terminal records on the terminal.

The user may require change access to the terminal file and records, and modify them in accordance with user needs. Example offline operations are described below.

In 206, the terminal may optionally create a new record responsive to user input. For example, the user may desire to create a new terminal record associated with the terminal file. For example, the user may create a new document associated with a contact in a contact management system. The new document may be a summary of a client interview held at the client's office.

It will be understood that the user may also create a new terminal file, which will be appropriately synchronized on the server in 214.

In 208, the terminal may optionally modify an existing record responsive to user input. For example, the user may desire to modify a terminal record associated with the terminal file. For example, the user may desire to update contact information associated with a contact in a contact management system during a client interview held at the client's office.

It will be understood that the user may also modify the existing terminal file. For example, the terminal file may include metadata describing the terminal file, which may be modified by the user.

In 210, the procedure may optionally delete an existing record responsive to user input. For example, the user may desire to delete a terminal record associated with the terminal file. For example, the user may discover during a client interview at the client's office that a record is no longer necessary.

In an alternative example embodiment, the user may not have permissions to delete records in accordance to regulations or other requirements.

It will be understood that the user may also delete the existing terminal file, which will be appropriately updated on the server in 214 by deleting the corresponding master file.

In 212, the procedure may optionally detect whether there is a network connection between the server and the mobile terminal. For example, the connection may be a wireless connection with a wireless router, a wired connection such as Ethernet or dial-up, or some other connection.

If yes, the procedure may proceed to 214, where synchronization may occur.

If no, the user may still be offsite and thus out of communication with the server. The user may desire to perform another offline operation on the terminal. The procedure may proceed to 204.

In 214, the procedure may synchronize the terminal file. The terminal may synchronize the terminal file over the network connection onto the server to its corresponding master file.

If a terminal record was created in 206, the terminal record may be copied to a new master record and associated with the corresponding master file on the server.

If a terminal record was modified in 208, the terminal record may be copied to the master record on the server corresponding to the terminal record.

If a terminal record was deleted in 210, the corresponding master record on the server may be deleted.

It will be understood that if a terminal file was created, modified, or deleted, the corresponding master file may also be created, modified, or deleted, respectively.

In 216, the procedure may end.

FIG. 3 illustrates an example system for synchronizing records, in accordance with one embodiment of the present invention. The system may be part of an enterprise network system that includes at least one terminal, a network, and a records management server. The enterprise network may be used by an enterprise in its day-to-day business, both conducting transactions relevant to its business and storing transaction as required.

A user 400 may interact with a terminal 402. A terminal 402 may be any device that is able to communicate with a records management server 416 over a network 426. For example, the terminal 402 may be a personal computer running a standard operating system such as Microsoft Windows or UNIX. The terminal 402 may include input devices such as a keyboard, a pointer device, and a microphone. The terminal 402 may include output devices such as a display screen, audio speakers, and a printer. The terminal 402 may include a network interface for communicating over the network 426.

While only one terminal is depicted in FIG. 3, it is understood that the system may include any number of terminals.

The terminal 402 may be configured to execute a local application 404. It will be appreciated that the local application 404 may be any application that may be executed on the terminal 402 and requires access to records from the records management server 416. For example, the local application 404 may be an email application as depicted in FIG. 3 that automatically stores incoming emails as records. In an alternative embodiment, the local application 404 may be a records management application that allows the user 400 to maintain a set of records. In an alternative embodiment, the local application 404 may be a word processing application that automatically stores newly created documents, perhaps from previously-saved templates, on the records management server 416.

The terminal 402 may include a local database 406. The local database 406 may be stored on a storage medium accessible to the terminal 402 such as a hard drive, a flash drive, or other writeable medium. The local database 406 may be configured to store records in a relational database, a flat file, or another format.

The terminal 402 may include record 408. The record 408 may be a record created on the terminal 402 by the local application 404, or a copy of a record stored on the records management server 416. Locally, the record 408 may be stored in local database 406.

The record 408 may include an identifier 410. For example, the identifier 410 may be associated with the record 408 and may be, for example, an incoming e-mail's sender or a recipient of a form letter created by a word process application. The identifier 410 may be unique within the local database 406 or in the records management server 416. In one embodiment, the record 408 may be an incoming email and the identifier may be the sender of the email, a business partner whom the user 400 is responsible for.

The terminal 402 may include any number of records. FIG. 3 depicts terminal 402 with additional records 412 and 414. For example, the records on the terminal 402 may be stored in the local database 406.

In an alternative embodiment, the terminal 402 may be a thin client and the local application 404 may execute on a remote applications server (not depicted), with inputs and outputs transmitted over the network 426. In an alternative embodiment, the local database 406 and the records 408, 412, and 414 may be stored at a computer remote from the terminal. In such an embodiment, the terminal 402 would communicate with the computer over a communications network, either network 426 or a separate network.

The network 426 may carry communications between the terminal 402 and the records management server 416. For example, the network 426 may be a standard or non-standard communication network such as the Internet, an intranet, a virtual private network, an Ethernet or other local network.

The records management server 416 may be a centrally located server which manages the records stored on behalf of the enterprise in the system. The server 416 may include hardware configured to execute a master database 418 including processors, hard drives, memory, and any other required components.

The server 416 may include a master database 418. The master database 418 may be configured to store all the records in the system, or just a specific subset. For example, a system may include multiple master databases, each database storing a subset of records.

The master database 418 may be a relational database optimized for fast storage and searches. The master database 418 may include a plurality of files 420, 426 and 428. It is appreciated that any number of files may be stored on the master database 418.

Each file may be a collection of one or more records associated together. There may be any number of records from record 1 422 to record N 424 included in a file. For example, a file may be all records associated with a particular business partner, and the records may include the business partner's contact information, past emails sent to and received from the business partner, documents or other attachments sent to and received from the business partner.

Several embodiments of the present invention are specifically illustrated and described herein. However, it will be appreciated that modifications and variations of the present invention are covered by the above teachings and within the purview of the appended claims without departing from the spirit and intended scope of the invention.

We claim:

1. A method for synchronizing records, comprising:
selecting at least one master file to be synchronized, wherein the master file includes a set of master records and is stored on a records management server, the server configured to store records relevant to enterprise activities and transactions;
copying the master file and the included master records from the server to a mobile terminal, the mobile terminal in intermittent communication with the server over a network;
performing an offline operation on a terminal file and an included set of terminal records; and
synchronizing the terminal file to the master file when the mobile terminal is in communication with the server over the network.

2. The method of claim 1, wherein the offline operation is selected from the group consisting of:
creating a new terminal record associated with the terminal file,
modifying an existing terminal record, and
deleting an existing terminal record.

3. The method of claim 1, wherein the file to be synchronized is selected automatically by the server based on a terminal user's permissions.

4. The method of claim 1, wherein the master records and terminal records are selected from the group consisting of:
emails,
documents, and
contact information.

5. The method of claim 1, wherein the synchronizing includes copying new and updated terminal records to the server.

6. The method of claim 1, further comprising
automatically detecting a network connection between the terminal and the server and beginning the synchronizing when the connection is detected.

7. A system for synchronizing records, comprising:
a network;
a records management server configured to store records relevant to enterprise activities and transactions, the server including
a master database, including at least one master file, each master file including a set of master records; and
a mobile terminal in intermittent communication with the server over the network, including
a local database, including at least one terminal file, each terminal file including a set of terminal records, wherein each terminal record corresponds to a master record
wherein the terminal is configured to
perform an offline operation on the terminal file, and
synchronize the terminal file with the master file when the terminal is in communication with the server over the network.

8. The system of claim 7, wherein the offline operation is selected from the group consisting of:
creating a new terminal record associated with the terminal file,
modifying an existing terminal record, and
deleting an existing terminal record.

9. The system of claim 7, wherein the file to be synchronized is selected automatically by the server based on a terminal user's permissions.

10. The system of claim 7, wherein the master records and terminal records are selected from the group consisting of:
emails,
documents, and
contact information.

11. The system of claim 7, wherein the synchronizing includes copying new and updated terminal records to the server.

12. The system of claim 7, wherein the mobile terminal is further configured to automatically detect a network connection between the terminal and the server and begin the synchronizing when the connection is detected.

13. A method for synchronizing records, comprising:
selecting at least one master file to be synchronized, wherein the master file includes a set of master records and is stored on a records management server;
copying the master file and the included master records from the server to a mobile terminal, the mobile terminal in intermittent communication with the server over a network;
performing an offline operation on a terminal file and an included set of terminal records; and
synchronizing the terminal file to the master file when the mobile terminal is in communication with the server over the network.

14. The method of claim 13, wherein the offline operation is selected from the group consisting of:
creating a new terminal record associated with the terminal file,
modifying an existing terminal record, and
deleting an existing terminal record.

15. The method of claim 13, wherein the file to be synchronized is selected automatically by the server based on a terminal user's permissions.

16. The method of claim 13, wherein the master records and terminal records are selected from the group consisting of:
emails,
documents, and
contact information.

17. The method of claim 13, wherein the synchronizing includes copying new and updated terminal records to the server.

18. The method of claim 13, further comprising
automatically detecting a network connection between the terminal and the server and beginning the synchronizing when the connection is detected.
